(19) United States
(12) Patent Application Publication
(10) Pub. No.: US 2024/0144090 A1
(43) Pub. Date: May 2, 2024

(54) Scalable Multivariate Time Series Forecasting in Data Warehouse

(71) Applicant: Google LLC, Mountain View, CA (US)

(72) Inventors: Haoming Chen, Kirkland, WA (US); Xi Cheng, Kirkland, WA (US); Weijie Shen, Mountain View, CA (US); Amir Hossein Hormati, Seattle, WA (US); Honglin Zheng, Seattle, WA (US)

(21) Appl. No.: 18/385,587

(22) Filed: Oct. 31, 2023

Related U.S. Application Data
(60) Provisional application No. 63/420,917, filed on Oct. 31, 2022.

(51) Int. Cl. G06N 20/00

(52) U.S. Cl. CPC G06N 20/00

(57) ABSTRACT

Aspects of the disclosure are directed to an approach for training a multivariate time series forecasting model using linear regression and ARIMA. The training may be performed by accessing data stored in a data warehouse using structure query language commands. The disclosure further provides for forecasting utilizing the trained model.

### CROSS-REFERENCE TO RELATED APPLICATIONS

The present application claims priority to U.S. Provisional Application No. 63/420,917, filed Oct. 31, 2022, the disclosure of which is hereby incorporated by reference herein.

### BACKGROUND

Forecasting may be performed using machine learning models that leverage structured query language (SQL). However, such models only support univariate time series modeling. As a result, the models may be limited from considering external regressors.

While some multivariate time series methods exist, they are also limited. Statistical methods typically use models based on auto regression or moving average. Deep neural network (DNN) based methods typically use simple model architectures, such as Long Short-Term Memory (LTSM). However, such static architectures typically require large amounts of data, and when such data is not available the models may produce inaccurate results.

### BRIEF SUMMARY

Aspects of the disclosure are directed to multivariate time series modeling using linear regression and autoregressive integrated moving average (ARIMA) analysis. Such multivariate time series modeling may be performed using data in a warehouse, without extracting or moving the data. A warehouse is a data management system, which may support business intelligence and data analytics. The data warehouse may aggregate data from different sources into a central data store. In this regard, many features may be incorporated into the modeling with time data spanning a long time range. Moreover, because the data does not need to be extracted or moved to perform the modeling and projections, the present solution conserves bandwidth that would otherwise be consumed in transmitting the data. Further, it conserves local storage space that would otherwise be consumed in temporarily or permanently storing data outside of the warehouse for the modeling.

In a training phase implementing the linear regression, each data point is assigned an identifier. One or more features of the data may be set forth in feature columns, and a linear trend may be added to the features. The assigned identifiers may be used to join the feature data with the linear trend data, and a correlation matrix of the data may be generated. The correlation matrix may be manipulated to derive weights. For example, taking an inverse of the matrix, the inverse matrix may be multiplied with the targeted time series to obtain the weights. The weights are multiplied with the features to obtain a weighted sum, and a residual is computed as (target_time_series−weighted_sum). The residual is fitted by an ARIMA model. Using the scalability of a data warehouse, the multivariate time series model can be trained using hundreds of columns and unlimited rows of data.

In a forecasting phase, ARIMA may be used to forecast the residual. Using the weights saved in the training phase, the weighted sum is calculated with the future features. The forecasted residual is added to the weighted sum.

One aspect of the disclosure provides a method of training a multivariate forecasting model, comprising identifying target time series data, a time range, and one or more features, wherein the one or more features may be categorical or numerical. The method may further include performing decomposition on the target time series data and numerical features, resulting in decomposed target time series data and decomposed numerical features, performing linear regression based on the decomposed time series data, decomposed numerical features, and categorical features, computing a residual based on a the target time series data and a result of the linear regression, determining a forecasted residual based on the residual, and determining a multivariate time series forecast based on the results of the linear regression and the forecasted residual.

According to some examples, the decomposed target time series data may be the target time series data with at least one of holiday or seasonality data removed.

According to some examples, the decomposed numerical features are the numerical features with at least one or holiday or seasonality data removed.

According to some examples, performing linear regression comprises assigning weights to each of the decomposed numerical features. Assigning the weights may include calculating the matrix multiplication X′*X, where X′ is a traverse of X; calculating an inverse of the matrix multiplication; and multiplying the inverse with the target time series.

According to some examples, determining the forecasted residual may include computing an autoregressive integrated moving average (ARIMA) model.

According to some examples, determining the multivariate time series forecast may include summing the residual forecast with the result of the linear regression.

According to some examples, the method may further include encoding the categorical data with numeric values prior to performing the linear regression.

According to some examples, the target time series data is stored in a data warehouse and accessed from the data warehouse for the training using structured query language.

According to some examples, the method may further include forecasting the time series data using the multivariate forecasting model.

Another aspect of the disclosure provides a system for training a multivariate forecasting model. The system may include a data warehouse storing time series data, and one or more processors in communication with the data warehouse. The one or more processors may be configured to identify target time series data, a time range, and one or more features, wherein the one or more features may be categorical or numerical, perform decomposition on the identified target time series data and numerical features, resulting in decomposed target time series data and decomposed numerical features, perform linear regression based on the decomposed time series data, decomposed numerical features, and categorical features, compute a residual based on a the identified target time series data and a result of the linear regression, determine a forecasted residual based on the residual, and determine a multivariate time series forecast based on the results of the linear regression and the forecasted residual.

According to some examples, the decomposed target time series data may be the target time series data with at least one of holiday or seasonality data removed.

According to some examples, the decomposed numerical features are the numerical features with at least one or holiday or seasonality data removed.

According to some examples, performing linear regression comprises assigning weights to each of the decomposed numerical features. Assigning the weights may include calculating the matrix multiplication X′*X, where X′ is a transpose of X, calculating an inverse of the matrix multiplication, and multiplying the inverse with the target time series.

According to some examples, determining the forecasted residual comprises computing an autoregressive integrated moving average (ARIMA) model.

According to some examples, determining the multivariate time series forecast comprises summing the residual forecast with the result of the linear regression.

According to some examples, the one or more processors are further configured to encode the categorical data with numeric values prior to performing the linear regression.

According to some examples, the target time series data is stored in a data warehouse and accessed from the data warehouse for the training using structured query language.

According to some examples, the one or more processors are further configured to forecast the time series data using the multivariate forecasting model.

Yet another aspect of the disclosure provides a non-transitory computer-readable medium storing instructions executable by one or more processors for performing a method, including identifying target time series data, a time range, and one or more features, wherein the one or more features may be categorical or numerical, performing decomposition on the target time series data and numerical features, resulting in decomposed target time series data and decomposed numerical features, performing linear regression based on the decomposed time series data, decomposed numerical features, and categorical features, computing a residual based on a the target time series data and a result of the linear regression, determining a forecasted residual based on the residual, and determining a multivariate time series forecast based on the results of the linear regression and the forecasted residual.

### BRIEF DESCRIPTION OF THE DRAWINGS

FIG. 1 depicts a block diagram of modeling pipeline according to aspects of the disclosure.

FIG. 2 depicts a flow diagram of an example method of training a multivariate forecasting model according to aspects of the disclosure.

FIG. 3 depicts a flow diagram of an example process for forecasting using a multivariate forecasting model according to aspects of the disclosure.

FIG. 4 depicts a block diagram of an example environment for implementing the forecast system according to aspects of the disclosure.

### DETAILED DESCRIPTION

The present disclosure provides for multivariate time series modeling using linear regression and autoregressive integrated moving average (ARIMA) analysis. Such multivariate time series modeling may be performed using data in a warehouse, without extracting or moving the data. In a training phase implementing the linear regression, each data point is assigned an identifier. One or more features of the data may be set forth in feature columns, and a linear trend may be added to the features. The assigned identifiers may be used to join the feature data with the linear trend data, and a correlation matrix of the data may be generated. The correlation matrix may be manipulated to derive weights, which are multiplied with the features to obtain a weighted sum, and a residual is computed. The residual is fitted by an ARIMA model. In a forecasting phase, ARIMA may be used to forecast the residual. Using the weights saved in the training phase, the weighted sum is calculated with the future features. The forecasted residual is added to the weighted sum.

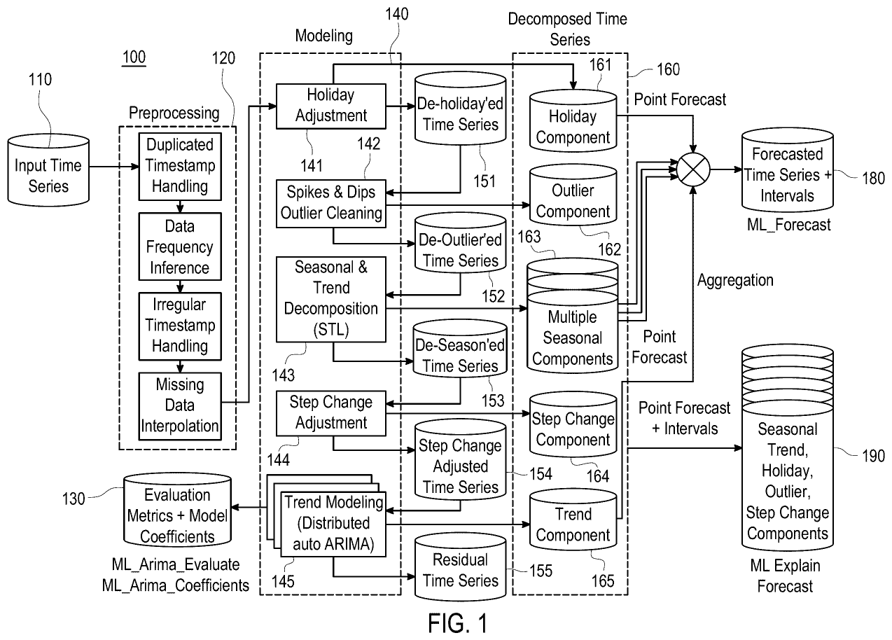

FIG. 1 depicts an example modeling pipeline 100. The modeling pipeline 100 includes a plurality of modules, including an ARIMA module. The ARIMA module may be configured to model a trend component of a forecast. It may further be configured to perform hyperparameter tuning.

As shown in FIG. 1, time series 110 may be input to a pre-processing phase 120 of the modeling pipeline 100. The pre-processing phase 120 may include, for example, duplicated timestamp handling, data frequency interference, irregular timestamp handling, and missing data interpolation. Duplicated timestamp handling may include resolving data points having duplicate timestamps, such as determining whether data points are duplicative and deleting the duplicates. Data frequency interference may include interfering the frequency in the data, such as hourly data, daily data, weekly data. Irregular timestamp handling may include aligning the timestamp of the data to a fixed interval, such as converting the timestamp “1:00”, “2:00”, “3:02” and “4:00” to “1:00”, “2:00”, “3:00” and “4:00”. Missing data interpolation may include filling the missing data, such as filling “3:00” when the data is “1:00”, “2:00” and “4:00”.

At a next phase of the pipeline 100, the pre-processed data from pre-processing phase 120 is input to modeling phase 140. The modeling phase 120 may include a trend modeling module 145 which may include an ARIMA module. Other modules in the modeling phase 140 may include, for example, a holiday adjustment module 141, a spikes and dips outlier cleaning module 142, a seasonal and trend decomposition module 143, a step change adjustment module 144, etc. While these are a few examples, it should be understood that additional or fewer modules may be included, and in some examples the modules may vary from the examples shown in FIG. 1.

In the modeling phase 140 in the example shown, the pre-processed data is input to a pipeline including a plurality of modules. The modeling phase 140 may include decomposition of time series data, deconstructing the data into one or more components, wherein each of the components represents underlying categories of patterns. Decomposition may include breaking down time series data into many components or identifying seasonality and trend from a series of data. Deconstruction may include separating the data into components. In each module, different parts of the data are extracted before feeding the data to a next module. For example, as shown, in a first module, the holiday adjustment module 141, data corresponding to particular holidays is extracted from the initial data and separately stored as holiday component 161 of decomposed time series data 160. Remaining de-holidayed time series data 151, which no longer includes the holiday component, is input to a spikes and dips outlier cleaning component 142 in the modeling phase 140. In this component, outliers are extracted into outlier component 162 and remaining data 152 is input to seasonal and trend decomposition module 143. Seasonal components 163 are extracted and remaining data 153 is input to a step change adjustment module 144. A step change component 164 is extracted and a step-change adjusted time series 154 is input to trend modeling module 145. A trend component 165 is extracted, leaving residual time series data 155.

The trend modeling component may output evaluation metrics and model coefficients 130. These evaluation metrics and model coefficients 130 may be used in the trend modeling 145, and stored separately for possible customer or administrator or other review. For example, the metrics and coefficients may be stored in a table, spreadsheet, or other format. Decomposed time series data 160 is derived from the modeling phase 140 as described above. As such, components of the decomposed time series data 160 may correspond to the modules 141-145 in the modeling phase 140. In the example shown, the decomposed time series data 160 includes a holiday component 161, an outlier component 162, multiple seasonal components 163, a step change component 164, and a trend component 165. However, it should be understood that the decomposed time series data 160 may differ depending on the modeling 140. The decomposed time series data 160 may be stored in one or more storage areas 190.

Some of the data from the decomposed time series data 160 is aggregated to derive a forecasted time series with intervals 180. In some examples, some data components are omitted from the aggregation. For example, as shown in FIG. 1, the holiday component 161, multiple seasonal components 163, and trend component 165 are aggregated, while outlier component 162 and step change component 164 are omitted.

A multivariate model using linear regression and ARIMA may be generated using any of a number of techniques. Statistical multivariate models may include ARIMA models utilizing vector autoregressive, linear regression on a right-hand side of the ARIMA model, external regressor, etc.

A model utilizing vector autoregressive may be represented by the following formula:

yₜ=c+A₁yₜ₋₁+A₂yₜ₋₂+ ⋅ ⋅ ⋅ +Aₚyₜ₋ₚ+eₜ
where y represents a target value, the target value being a vector of size k; p represents a parameter; t is the time; c is a constant vector; Aᵢ is a k×k matrix; and eₜ is an error term. Parameter p may be a number of past points used to model the current data. For example, to model a daily sales data, if p=3, and A1, A2, A3 are 0.2, 0.3, 0.5 in the equation, today's data is 0.2*(data of 3 days ago)+0.3*(data of 2 days ago)+0.5*(yesterday's data). The error term may be modeled as a vector moving average with a parameter q. The parameter q may be similar to p, which uses data in the past to model the current data, but q uses the error (e.g., actual data−modeled data) from the previous dates, instead of the data itself like p. The error term may be modeled using the following formula:

eₜ=uₜ+M₁uₜ₋₁+ ⋅ ⋅ ⋅ +M_{q}u_{t-q}

This model may support endogenous variables, but can also be extended to support exogenous variables.

For a model utilizing linear regression on a right-hand side of the ARIMA model, for (p, d, q), where d=0 and p and q are parameters, the model may be:

yₜ=β₀+β_{1,t}+ ⋅ ⋅ ⋅ +βₖx_{k,t}+φ₁yₜ₋₁+ ⋅ ⋅ ⋅ φₚyₜ₋ₚ−θ₁zₜ₋₁−⋅ ⋅ ⋅ −θ_{q}z_{t-q}+zₜ
where yₜ represents the target value at time t. Using backshift operators, the model may be:

ϕ(B)yₜ=βxₜ+θ(B)zₜ
where yₜ is a scalar, covariates vector xₜ is of size k and β is 1×k.

ARIMA plus external regressor models a linear regression error, such as by:

yₜ=β₀+β₁x_{1,t}+ ⋅ ⋅ ⋅ +βₖx_{k,t}+ηₜ

where yₜ is the target value at time t, x_{i,t} are the exogenous variables, lit is the error term, which is modeled by ARIMA as:

ηₜ=φ₁ηₜ₋₁+ ⋅ ⋅ ⋅ +φₚηₜ₋ₚ−θ₁zₜ₋₁− ⋅ ⋅ ⋅ −θ_{q}z_{t-q}+zₜ

Using backshift operators, the model is:

$${y}_{t} = β {x}_{t} + \frac{θ ( B )}{ϕ ( B )} {z}_{t}$$

A derivation based on the previous two equations is:

$${y}_{t} - β {x}_{t} = {η}_{t}$$

$${η}_{t} - {φ}_{1} {η}_{t - 1} - … - {φ}_{p} {η}_{t - p} = - {θ}_{1} {z}_{t - 1} - … - {θ}_{q} {z}_{t - q} + {z}_{t} = > ϕ ( B ) {η}_{t} = θ ( B ) {z}_{t} = > {η}_{t} = \frac{θ ( B )}{ϕ ( B )} {z}_{t}$$

$$yt = β {x}_{t} + \frac{θ ( B )}{ϕ ( B )} {z}_{t}$$

In this model, both y and xᵢ should be stationary. For non-stationary data, a non zero differencing d may be applied.

A training process may be used to train the multivariate time series model, while a forecasting process may be used to compute forecasts using the trained multivariate time series model. Training data can correspond to training forecast models. The training data can be in any form suitable for training the forecast models, according to one of a variety of different learning techniques. Learning techniques for training the forecast models can include supervised learning, unsupervised learning, and semi-supervised learning techniques. For example, the training data can include multiple training examples that can be received as input by the forecast models. The training examples can be labeled with a desired output for the forecast models when processing the labeled training examples. The label and the model output can be evaluated by the evaluation metrics, which can be backpropagated through the forecast model to update weights for the forecast model.

The forecasting may produce results as a set of computer-readable instructions, such as one or more computer programs, which can be executed to further train, fine-tune, and/or deploy the forecast models. A computer program can be written in any type of programming language, and according to any programming paradigm, e.g., declarative, procedural, assembly, object-oriented, data-oriented, functional, or imperative. A computer program can be written to perform one or more different functions and to operate within a computing environment, e.g., on a physical device, virtual machine, or across multiple devices. A computer program can also implement functionality described in this specification, for example, as performed by a system, engine, module, or model.

The aggregation may include an aggregation scheme based on the features of the forecast to be performed. For example, the aggregation scheme can include summing or averaging values that satisfy a condition for the forecast when features of the forecast are numerical. The aggregation scheme can also include a most frequent value or a concatenate of unique values that satisfy a condition for the forecast when features of the forecast are categorical. The aggregation scheme can be predetermined based on a type of feature, such as a numerical or categorical feature. The aggregation scheme can also be selected based on a particular feature, such as inventory, returns, replenishment, or price for a sales prediction target.

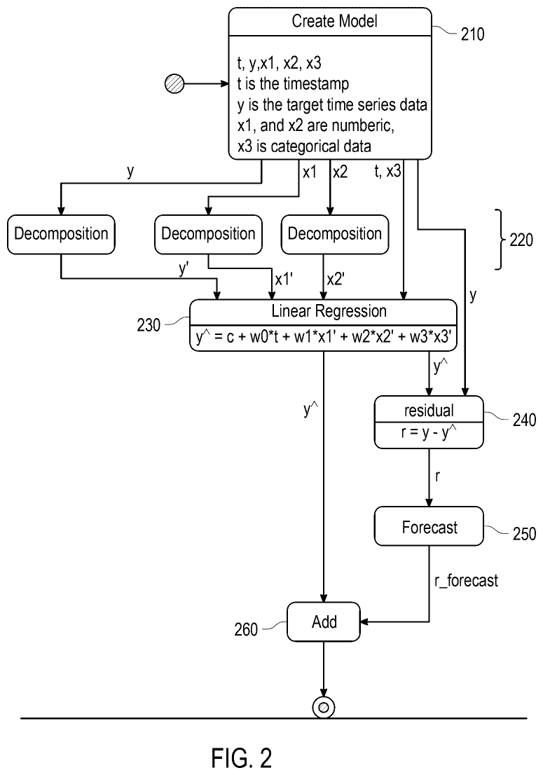

FIG. 2 depicts an example flow for training the multivariate time series model. In block 210, a model is created. Training the multivariate time series model using linear regression and ARIMA may be based on a target value y and covariates x₁, x₂, . . . xₙ for time t. The covariates may be numerical or categorical. By way of example, if the target value y corresponds to a number of bicycles shared in a given geographic location over a period of time, covariates may include information such as temperature, humidity, windspeed, and weather. While temperature, humidity, and windspeed may be numerical values, weather is categorical. For example, the weather may be clear, misty, light snow, heavy rain, sunny, etc. The categorical features may be static or non-static. Static features may remain unchanged over time, such as a brand for a consumer electronic device. Non-static features may change over time. Weather is an example of a non-static features, as one day it may be raining and the next day it may be sunny, etc. In some examples, encodings can be used to convert non-static categorical time series data to numerical time series. For example, misty when may be assigned a first numeric value, snow may be assigned a second different numeric value, etc.

Creating the model may include saving all data that may be needed for future computations. Such data may include, for example, univariate forecasting for different components, model weights, residuals, seasonality components, etc.

In block 220, a seasonality and holiday decomposition model may be conducted on all x; and y, for all numerical values. This can also remove a seasonal confounder. For example, in predicting ice cream sales, a feature might be a frequency of mowing the lawn. Without removing seasonality, a strong correlation between the ice cream sales and the frequency of mowing the lawn may be presented, because both increase during summer months and decrease during winter months. However, for forecasting purposes the correlation does not make much sense.

Decomposition may be skipped for categorical variables. In the example illustrated, decomposition is performed for y, x₁, and x₂. However, as x₃ is a categorical value, as opposed to a numerical value like x₁ and x₂, decomposition is skipped for x₃ and well as for t. After removing holiday effects and seasonality, the remaining de-holidayed data and de-seasonality data is represented in FIG. 2 as y′, xᵢ′.

In block 230, linear regression is performed on historical data with optional L1 or L2 regularization. For example, the linear regression may be computed using:

y′ₜ=c+β₀t+β₁x′_{1,t}+ ⋅ ⋅ ⋅ +βₙx′_{nx′}

where β is the weights of the linear regression. β may be calculated by: calculating the matrix multiplication X′ *X, where X′ is the transpose of X, by joining the feature with itself; calculating the inverse of the matrix multiplication; and multiplying the inverse with the target time series. The t is to model the linear trend. It may be equivalent to difference d=0 or d=1. For example, among (p,d,q), d=0 means the target time series has no linear trend. d=1 means there is a linear trend of the target time series. Setting the timestamp t is to model these two cases, such that if β₀=0, it is dam, and if β₀ is non-zero, it is d=1. According to some examples, t may be represented as an integer with many digits. In such cases, the time value may be normalized by taking an offset of the start time and dividing it by the entire range.

The model may ignore correlations between lagged data. In some examples, lagged data may be supported by allowing users to specify a certain lag for a certain feature column, or by auto-lag detection in which all x, to xₜ₋ₖ are included in the regression model and the one with the most significant weight is chosen.

Calculating the fitted part:

ŷₜ=β₁x₁ₜ′+β₂x₂ₜ′+ ⋅ ⋅ ⋅ βₙxₙₜ′

ŷ includes both historical and forecasted data. For example, it identifies a linear trend based on the decomposed historical data, and also projects future data based on the identified linear trend. The holiday and seasonality components that were extracted in the modeling are extended to forecasting future times.

In block 240, a residual r is computed using r=y−ŷ. In block 250, ARIMA may be applied to the residual to obtain a forecasted residual r_forecast.

In block 260 a final forecast y_forecast is obtained by combining the residual forecast from block 250 with the fitted linear regression ŷ. For example, the final forecast may be represented as:

y_{forecast}=r_{forecast}+y_{forecast}

The error of linear regression may be modeled in the forecasting term, so prediction interval PI of y will be: (r_{forecast}′sPI+ŷ_{forecast}).

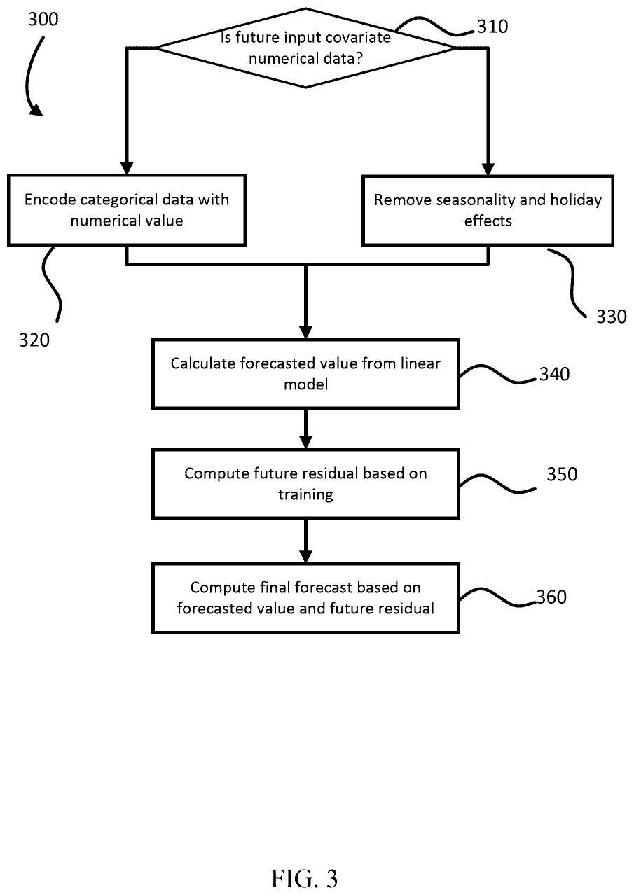

FIG. 3 depicts a flow diagram of an example process 300 for forecasting using a trained multivariate time series model using linear regression and ARIMA. The example process 300 can be performed on a system of one or more processors in one or more locations, such as in a data warehouse. While the operations of FIG. 3 are described in a particular order, it should be understood that the order may be varied or operations may overlap or be performed simultaneously. Moreover, operations may be added or omitted.

In the forecasting process 300, future input covariates x_{future} that include numerical data may be handled separately from future input covariates that include categorical information. If in block 310 it is determined that the future input covariate is not numerical data, and is therefore categorical data, the categorical data may be encoded in block 320 with numerical values. For example, if the future input covariate is weather as mentioned above in the example for the training model, categories such as sunny, hazy, raining, etc. may be encoded with values such as 1, 2, 3, etc.

In block 330, seasonality and holiday effects are removed from the future input covariates that are numerical data. Removing the seasonal and holiday effects may include, for example, a decomposition process such as discussed above in connection with FIG. 1. The remaining data from which seasonal and holiday effects were removed may be denoted as x′_{future}.

In block 340, a forecasted covariate value may be computed from a linear model. For example, the forecasted value may be computed as:

ŷ_{future}=βx′_{future}

In block 350, a future residual may be computed based on the training process. For example, the future residual may be a projection of target data based on the training process described in connection with FIG. 2. By way of example, if the target data is number of bicycles sold, the future residual may be a projection of how many bicycles will be sold in a future 30 day time period based on the training model. For example, the future residual may be computed using a formula such as the ARIMA model. As a simplified example, if the parameter p is 3 and A1, A2, A3 are 0.5, 0.3, and 0.2, the next day's forecast value is tomorrow=0.5*today+0.3*yesterday+0.2*(2 days ago). The process can be repeated to get an arbitrary number of forecasted days' data.

In block 360, a final forecast may be computed based on the forecasted covariate value and the future residual value. For example, the final forecast may be the sum of the forecasted covariate value and the future residual value.

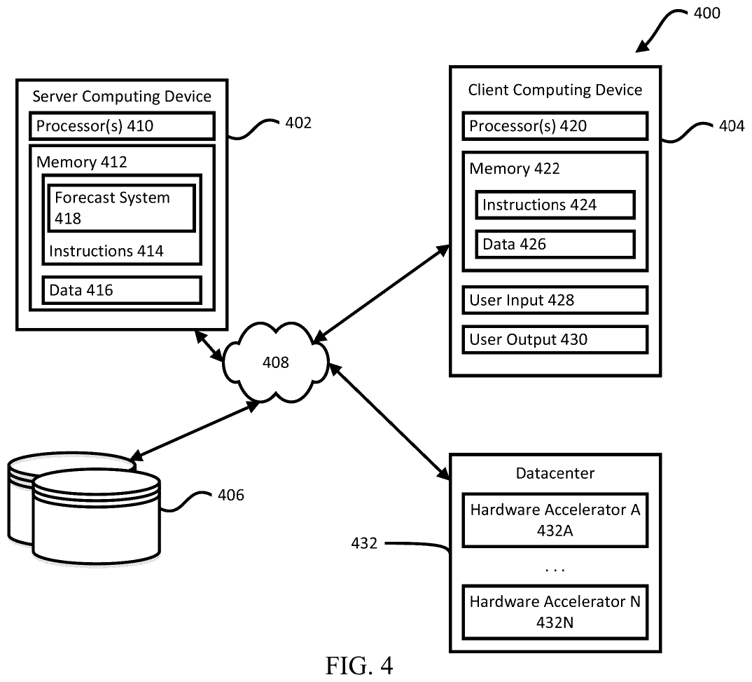

FIG. 4 depicts a block diagram of an example environment 400 for implementing training multivariate time series models using linear regression and ARIMA, and forecasting using such models. The system 400 can be implemented on one or more devices having one or more processors in one or more locations, such as in server computing device 402. Client computing device 404 and the server computing device 402 can be communicatively coupled to one or more storage devices 406 over a network 408. The storage devices 406 can be a combination of volatile and non-volatile memory and can be at the same or different physical locations than the computing devices 402, 404. For example, the storage devices 406 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 402 can include one or more processors 410 and memory 412. The memory 412 can store information accessible by the processors 410, including instructions 414 that can be executed by the processors 410. The memory 412 can also include data 416 that can be retrieved, manipulated, or stored by the processors 410. The memory 412 can be a type of non-transitory computer readable medium capable of storing information accessible by the processors 410, such as volatile and non-volatile memory. The processors 410 can include one or more central processing units (CPUs), graphic processing units (GPUs), field-programmable gate arrays (FPGAs), and/or application-specific integrated circuits (ASICs), such as tensor processing units (TPUs).

The instructions 414 can include one or more instructions that when executed by the processors 410, causes the one or more processors to perform actions defined by the instructions. The instructions 414 can be stored in object code format for direct processing by the processors 410, or in other formats including interpretable scripts or collections of independent source code modules that are interpreted on demand or compiled in advance. The instructions 414 can include instructions for implementing a forecast system 418. The forecast system 418 can be executed using the processors 410, and/or using other processors remotely located from the server computing device 402.

The data 416 can be retrieved, stored, or modified by the processors 410 in accordance with the instructions 414. The data 416 can be stored in computer registers, in a relational or non-relational database as a table having a plurality of different fields and records, or as JSON, YAML, proto, or XML documents. The data 416 can also be formatted in a computer-readable format such as, but not limited to, binary values, ASCII or Unicode. Moreover, the data 416 can include information sufficient to identify relevant information, such as numbers, descriptive text, proprietary codes, pointers, references to data stored in other memories, including other network locations, or information that is used by a function to calculate relevant data.

The client computing device 404 can also be configured similarly to the server computing device 402, with one or more processors 420, memory 422, instructions 424, and data 426. The client computing device 404 can also include a user input 428, and a user output 430. The user input 428 can include any appropriate mechanism or technique for receiving input from a user, such as keyboard, mouse, mechanical actuators, soft actuators, touchscreens, microphones, and sensors.

The server computing device 402 can be configured to transmit data to the client computing device 404, and the client computing device 404 can be configured to display at least a portion of the received data on a display implemented as part of the user output 430. The user output 430 can also be used for displaying an interface between the client computing device 404 and the server computing device 402. The user output 430 can alternatively or additionally include one or more speakers, transducers or other audio outputs, a haptic interface or other tactile feedback that provides non-visual and non-audible information to the platform user of the client computing device 404.

Although FIG. 4 illustrates the processors 410, 420 and the memories 412, 422 as being within the computing devices 402, 404, components described herein can include multiple processors and memories that can operate in different physical locations and not within the same computing device. For example, some of the instructions 414, 424 and the data 416, 426 can be stored on a removable SD card and others within a read-only computer chip. Some or all of the instructions and data can be stored in a location physically remote from, yet still accessible by, the processors 410, 420. Similarly, the processors 410, 420 can include a collection of processors that can perform concurrent and/or sequential operation. The computing devices 402, 404 can each include one or more internal clocks providing timing information, which can be used for time measurement for operations and programs run by the computing devices 402, 404.

The server computing device 402 can be connected over the network 408 to a datacenter 432 housing hardware accelerators 432A-N. The datacenter 432 can be one of multiple datacenters or other facilities in which various types of computing devices, such as hardware accelerators, are located. The computing resources housed in the datacenter 432 can be specified for deploying forecast models, as described herein.

The server computing device 402 can be configured to receive requests to process data 426 from the client computing device 404 on computing resources in the datacenter 432. For example, the environment 400 can be part of a computing platform configured to provide a variety of services to users, through various user interfaces and/or APIs exposing the platform services. One or more services can be a machine learning framework or a set of tools for generating and/or utilizing forecasting neural networks or other machine learning forecasting models and distributing forecast results according to a target evaluation metric and/or training data. The client computing device 404 can receive and transmit data specifying the target evaluation metrics to be allocated for executing a forecasting model trained to perform demand forecasting. The forecast system 418 can receive the data specifying the target evaluation metric and/or the training data, and in response generate one or more forecasting models and distribute result of the forecast models based on the target evaluation metric, to be described further below.

As other examples of potential services provided by a platform implementing the environment 400, the server computing device 402 can maintain a variety of forecasting models in accordance with different information or requests. For example, the server computing device 402 can maintain different families for deploying neural networks on the various types of TPUs and/or GPUs housed in the datacenter 432 or otherwise available for processing.

The devices 402, 404 and the datacenter 432 can be capable of direct and indirect communication over the network 408. For example, using a network socket, the client computing device 404 can connect to a service operating in the datacenter 432 through an Internet protocol. The devices 402, 404 can set up listening sockets that may accept an initiating connection for sending and receiving information. The network 408 itself can include various configurations and protocols including the Internet, World Wide Web, intranets, virtual private networks, wide area networks, local networks, and private networks using communication protocols proprietary to one or more companies. The network 408 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 408, in addition or alternatively, can also support wired connections between the devices 402, 404 and the datacenter 432, including over various types of Ethernet connection.

Although a single server computing device 402, client computing device 404, and datacenter 432 are shown in FIG. 4, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing neural networks, and any combination thereof.

Example Use Cases:

According to one example use case, a multivariate time series model may be created. For example, a user may run a CREATE MODEL query to create and train the multivariate model. The user may select target time series data and features.

According to another example use case, the multivariate time series model may be forecasted. For example, the user may run an SQL to compose a new query. The user may select a date and features. Selecting the date may ensure that the timestamp of future covariates and the model's horizon timestamps match, wherein the horizon is the number of time points to forecast. If the horizon is smaller than the date, only the number of the horizon may be forecasted.

According to another example use case, the multivariate time series model may be evaluated. For example, the user may run an EVALUATE function. The EVALUATE function runs the FORECAST and then uses forecasted data and actual data to calculate the errors.

According to another example use case, large scale multivariate time series forecasting may be performed. For example, time series forecasting may be performed using data for an entire company, department, or the like using a large time span.

Another example use case may include inspecting and fine tuning the multivariate time series model. For example, the user may inspect underlying weights of the multivariate time series model, or may inspect the multivariate time series model coefficient. In other examples, the user may use hyperparameter tuning to improve multivariate performance. In further examples, the user may want to understand how much each feature in the model contributed to the final forecast. In such case, the user can run a function that explains the forecast and top feature attributions.

Another example use case may include detecting anomalies using the multivariate time series model. For example, the user may run a function to detect anomalies in historical data or future data. Given a target ŷ, the actual y and the standard error of the ARIMA error, the probability of an anomaly is:

$${P}_{anomaly} = \vert 1 - 2 Φ ( \frac{y - \hat{y}}{standard error} ) \vert$$

Users can specify a probability threshold to filter out the potential anomalies.

The system and method described above are advantageous in that the data used for training and forecasting does not need to be extracted or moved to perform the modeling and projections. Accordingly, the present solution conserves bandwidth that would otherwise be consumed in transmitting the data. Further, it conserves local storage space that would otherwise be consumed in temporarily or permanently storing data outside of the warehouse for the modeling.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of training a multivariate forecasting model in a system comprising a data warehouse arranged for storing time series data and one or more processors in communication with the data warehouse, the method comprising:
identifying target time series data, a time range, and one or more features, wherein the one or more features may be categorical or numerical;
performing decomposition on the target time series data and numerical features, resulting in decomposed target time series data and decomposed numerical features;
performing linear regression based on the decomposed time series data, decomposed numerical features, and categorical features;
computing a residual based on the target time series data and a result of the linear regression;
determining a forecasted residual based on the residual; and
determining a multivariate time series forecast based on the results of the linear regression and the forecasted residual.

2. The method of claim 1, wherein the decomposed target time series data is the target time series data with at least one of holiday or seasonality data removed.

3. The method of claim 1, wherein the decomposed numerical features are the numerical features with at least one or holiday or seasonality data removed.

4. The method of claim 1, wherein performing linear regression comprises assigning weights to each of the decomposed numerical features.

5. The method of claim 4, wherein assigning the weights comprises:
calculating the matrix multiplication X′*X, where X′ is a traverse of X;
calculating an inverse of the matrix multiplication; and
multiplying the inverse with the target time series.

6. The method of claim 1, wherein determining the forecasted residual comprises computing an autoregressive integrated moving average (ARIMA) model.

7. The method of claim 1, wherein determining the multivariate time series forecast comprises summing the residual forecast with the result of the linear regression.

8. The method of claim 1, further comprising encoding the categorical data with numeric values prior to performing the linear regression.

9. The method of claim 1, wherein the target time series data is stored in a data warehouse and accessed by the at least one processor from the data warehouse for the training using structured query language.

10. The method of claim 1, further comprising forecasting the time series data using the multivariate forecasting model.

11. A system for training a multivariate forecasting model, comprising:
a data warehouse storing time series data;
one or more processors in communication with the data warehouse, the one or more processors configured to:
identify target time series data, a time range, and one or more features, wherein the one or more features may be categorical or numerical;
perform decomposition on the identified target time series data and numerical features, resulting in decomposed target time series data and decomposed numerical features;
perform linear regression based on the decomposed time series data, decomposed numerical features, and categorical features;
compute a residual based on the identified target time series data and a result of the linear regression;
determine a forecasted residual based on the residual; and
determine a multivariate time series forecast based on the results of the linear regression and the forecasted residual.

12. The system of claim 11, wherein the decomposed target time series data is the target time series data with at least one of holiday or seasonality data removed.

13. The system of claim 11, wherein the decomposed numerical features are the numerical features with at least one or holiday or seasonality data removed.

14. The system of claim 11, wherein performing linear regression comprises assigning weights to each of the decomposed numerical features.

15. The system of claim 14, wherein assigning the weights comprises:
calculating the matrix multiplication X′*X, where X′ is a transpose of X;
calculating an inverse of the matrix multiplication; and
multiplying the inverse with the target time series.

16. The system of claim 11, wherein determining the forecasted residual comprises computing an autoregressive integrated moving average (ARIMA) model.

17. The system of claim 11, wherein determining the multivariate time series forecast comprises summing the residual forecast with the result of the linear regression.

18. The system of claim 11, wherein the one or more processors are further configured to encode the categorical data with numeric values prior to performing the linear regression.

19. The system of claim 11, wherein the target time series data is stored in a data warehouse and accessed from the data warehouse for the training using structured query language.

20. The system of claim 11, wherein the one or more processors are further configured to forecast the time series data using the multivariate forecasting model.
